(19) United States
(12) Patent Application Publication
(10) Pub. No.: US 2025/0360529 A1
(43) Pub. Date: Nov. 27, 2025

(54) APPLICATOR FOR APPLYING AN APPLICATION AGENT

(71) Applicant: Dürr Systems AG, Bietigheim-Bissingen (DE)

(72) Inventors: Bernd Kraft, Steinheim a.d. Murr (DE); Werner Schwager, Ludwigsburg (DE); Frank Schnur, Bönnigheim (DE); Lothar Rademacher, Bietigheim-Bissingen (DE)

(21) Appl. No.: 18/875,113

(22) PCT Filed: Jun. 5, 2023
(86) PCT No.: PCT/EP2023/065011

§ 371 Date: Dec. 13, 2024

(30) Foreign Application Priority Data
Jun. 13, 2022 (DE) 10 2022 114 833.5

(51) Int. Cl. B05B 13/02; B05B 13/04; B05B 15/65

(52) U.S. Cl. CPC B05B 13/0278; B05B 13/0433; B05B 15/65

(57) ABSTRACT

An applicator for applying an application agent (e.g. sealant, insulating material) to a component (e.g. motor vehicle body component). The applicator having a mounting flange, in particular for mounting the applicator on an application robot, a plurality of nozzles for emitting a respective jet of the application agent onto the component, wherein the nozzles are each designed as a separate component, and an applicator head at the distal end of the applicator, wherein the applicator head includes a respective nozzle holder for mounting the individual nozzles. The individual nozzles are each mounted directly in the associated nozzle holders of the applicator head.

### CROSS-REFERENCE TO RELATED APPLICATIONS

This application is a national stage of, and claims priority to, Patent Cooperation Treaty Application No. PCT/EP2023/065011, filed on Jun. 5, 2023, which application claims priority to German Application No. DE 10 2022 114 833.5, filed on Jun. 13, 2022, which applications are hereby incorporated herein by reference in their entireties.

### TECHNICAL FIELD

The disclosure relates to an applicator for applying an application agent (e.g. sealant, insulating material) to a component (e.g. motor vehicle body component).

### BACKGROUND

In the field of sealant application (“sealing”) for the sealing of vehicle bodies, so-called 3D applicators (“3D guns”) have been standard in application technology for many years. These well-known 3D applicators are usually designed by the well-known manufacturers in such a way that they have a manufacturer-specific standardized interface at the end of a lance for holding the nozzles. Various nozzles are then mechan-ically adapted to this interface as required. For this purpose, the nozzles have a base body that fits the mechanical holder of the 3D applicator and can be mounted with repeat accuracy using a mounting plate.

This type of nozzle adaptation proved to be quite practical as long as the nozzles could be designed with an equally compact “foot” due to their compact size. However, this has changed with the introduction of nozzles for the application of e.g. liquid insulating materials or standing seams. These nozzles have a multi-part design (see DE 10 2011 011 850 A1) and are larger than airless or flatstream nozzles, for example, due to their geometric dimensions.

For this reason, the nozzles according to the state of the art are constructed in such a way that first of all a nozzle body is mounted, which is constructed in several parts and accommodates the various plates required for the function. In order to be able to adapt this nozzle body to a 3D applicator, this nozzle body is connected to a suitable adapter plate. This complete assembly can then be fitted to the standardized holder of the 3D applicator with repeat accuracy.

FIGS. 1-4 show such a conventional applicator 1, which can be used to apply an insulating material or a sealant, as is known from the prior art. For this purpose, the known applicator 1 firstly has a mounting flange 2 with which the applicator 1 can be mounted on an application robot. In addition, the applicator 1 includes a rotary feedthrough 3 in which an elongated lance 4 is rotatably mounted. At the distal end of the lance 4 is a lance head 5 with an integrated valve block with main valves, as will be described in more detail. An applicator head 6, in which three flat jet nozzles 7-9 are mounted, is attached to the lance head 5. The flat jet nozzles 7-9 are each mounted in the applicator head 6 by an adapter 10-12. The individual flat jet nozzles 7-9 are screwed into the associated adapters 10-12 using screws 13-15. The adapters 10-12 with the flat jet nozzles 7-9 screwed into them are then mounted on the applicator head 6. The flat jet nozzles 7-9 are therefore not mounted directly and immediately in the applicator head 6, but by the adapters 10-12. As a result, the applicator 1 has a relatively large interfering contour 16 in a cross-sectional view at right angles to the longitudinal axis of the lance 4, as can be seen in FIG. 4. Thus, the interfering contour 16 of the conventional applicator 1 has a lateral extension a in a cross-sectional view at right angles to the longitudinal axis of the lance 4. In addition, the conventional applicator 1 also has a relatively large interfering contour 17 in a side view as shown in FIG. 9, which has a lateral extension c.

A disadvantage of the known applicator 1 described above is therefore the fact that the interfering contours 16, 17 of the known applicator 1 are relatively large. In some applications, this makes it more difficult to access the applicator 1 to the areas to be applied.

With regard to the technical background of the disclosure, reference should also be made to DE 10 2014 017 856 A1, DE 103 20 856 B3, US 2002/0 083 895 A1, US 2002/0 130 194 A1, DE 10 2017 008 227 A1 and DE 10 2010 056 071 A1.

### BRIEF DESCRIPTION OF THE DRAWINGS

FIG. 1 shows a perspective view of the known applicator described at the beginning.

FIG. 2 shows a perspective view of the applicator head of the known applicator according to FIG. 1.

FIG. 3 shows a side view of the applicator head as shown in FIGS. 1 and 2.

FIG. 4 shows a front view of the known applicator according to FIGS. 1-3 to illustrate the interfering contour.

FIG. 5 shows a corresponding front view with the interfering contour of an applicator according to the disclosed technology.

FIG. 6 shows a perspective view of the applicator according to the disclosure.

FIG. 7 shows a perspective view of the applicator according to the disclosure in the area of the applicator head.

FIG. 8 shows an enlarged perspective detail view of the applicator head.

FIG. 9 shows superimposed side views of the applicator head of the applicator according to the disclosure on the one hand and of the conventional applicator on the other hand.

FIG. 10 shows a schematic representation of an applicator according to the disclosure.

FIG. 11 shows a schematic representation of an application robot with an applicator according to the disclosed technology.

### DETAILED DESCRIPTION

The disclosed technology is based on the task of creating a correspondingly improved applicator which should have the smallest possible interfering contour. This task is solved by an applicator according to the claims.

The applicator according to the disclosure is generally suitable for the application of a fluid or paste-like application agent. Preferably, the applicator is designed for the application of a thick material, such as an insulating material, a sealant or an adhesive, to name but a few examples. However, the disclosure is not limited with regard to the application agent to application agents with specific properties.

Furthermore, it should be mentioned that the applicator according to the disclosure is preferably designed to apply the application agent (e.g. sealant, insulating material) to a motor vehicle body component. However, the disclosure is not limited to motor vehicle body components with regard to the component.

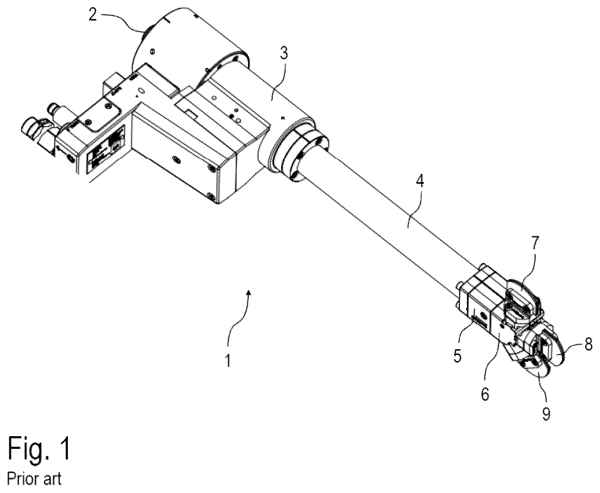

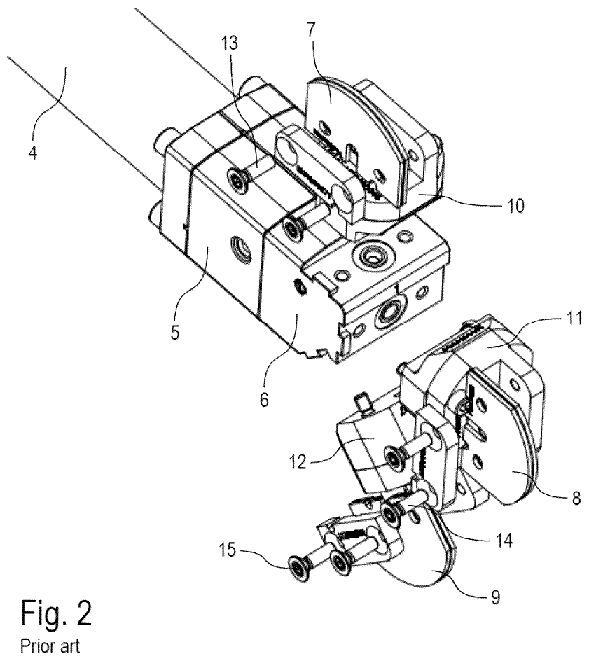

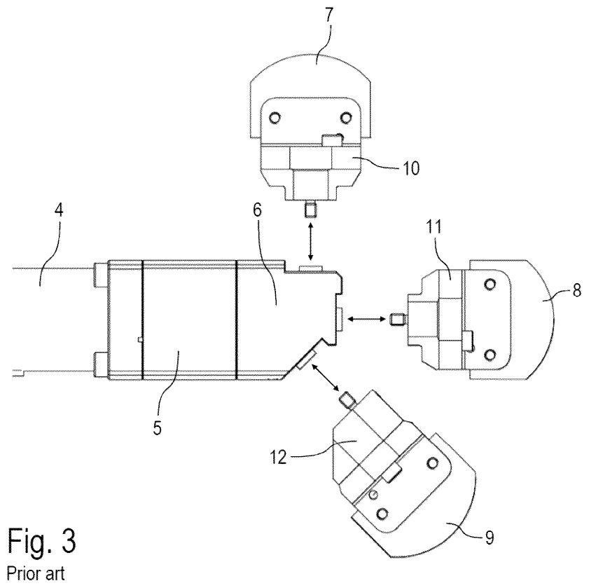

In accordance with the known applicator described with respect to FIGS. 1-4, the applicator according to the disclosure initially includes a mounting flange in order to be able to mount the applicator on a handling device, such as an application robot.

In addition, the applicator according to the disclosure also includes several nozzles in accordance with the known applicator described above, each of which can emit a jet of the application agent onto the component, whereby the nozzles are each designed as a separate component. In some embodiments of the disclosure, the applicator has a total of three nozzles, which is why such applicators are also referred to as 3D applicators (“3D gun”). However, the disclosure is not limited to exactly three nozzles with regard to the number of nozzles, but can also be realized with a different number of nozzles.

Furthermore, in accordance with the known applicator described at the with respect to FIGS. 1-4, the applicator according to the disclosure also has an applicator head at the distal end of the applicator, i.e. at the end of the applicator facing away from the mounting flange. In the applicator according to the disclosure, this applicator head also has several nozzle holders for receiving the individual nozzles.

The applicator according to the disclosure is now characterized by the fact that the individual nozzles are each mounted directly and immediately in the associated nozzle holders of the applicator head. This direct and immediate mounting of the individual nozzles in the nozzle holders of the applicator head according to the disclosure is to be distinguished from the indirect and mediate mounting of the nozzles in the nozzle holders described at the beginning. In the conventional applicator described above, the nozzles are mounted indirectly in the nozzle holders by adapters. In contrast, the disclosure dispenses with such adapters, so that the nozzles are mounted directly in the nozzle holders in the applicator head.

In some embodiments, the nozzles are each anchored directly in the associated nozzle holder of the applicator head by a force-fit or form-fit connection, for example by a screw connection. However, the disclosure is not limited to a screw connection with regard to the type of connection of the nozzles in the associated nozzle holder. Rather, other types of connection are also possible within the scope of the disclosure.

Furthermore, it should be mentioned that the nozzles in the disclosed embodiments each have a flat contact surface, as is also the case, for example, with conventional nozzles as described, for example, in DE 10 2011 011 850 A1. In the applicator according to the disclosure, the nozzle holders in the applicator head for mounting the nozzles preferably also each have a flat contact surface. In the assembled state, the flat contact surfaces of the nozzles on the one hand and the nozzle holders on the other hand are in plane-parallel contact with each other.

Furthermore, the applicator head can have a mounting groove to accommodate one of the nozzles, whereby one of the nozzles is mounted in the mounting groove in the applicator head. In some embodiments, this type of mounting by use of a mounting groove is only provided for one of the three nozzles. However, within the scope of the disclosure, it is also possible in principle for this type of mounting by use of a mounting groove to be provided for several or all nozzles.

It has already been mentioned above that the nozzles can be anchored in the nozzle holders by a screw connection. In the design described above with flat and plane-parallel contact surfaces of the nozzles on the one hand and the nozzle holders on the other, these screw connections can be aligned at right angles to the contact surfaces. The fastening screws can then be anchored in a threaded hole in the respective contact surface of the nozzle holder of the applicator head.

It has already been briefly mentioned above that the individual nozzles can each have several nozzle plates that are arranged parallel to one another, as described, for example, in DE 10 2011 011 850 A1. In this case, the nozzles can also have two clamping plates, with the nozzle plates being arranged between the two clamping plates, with the screw connection passing through the two clamping plates and the nozzle plate. The two clamping plates are therefore arranged on the outside of the nozzles and can also be referred to as counter plates.

In some embodiments of the disclosure, the nozzles are each flat jet nozzles, each of which emits a flat jet in a respective jet plane. The flat jet nozzles are preferably arranged in such a way that the jet planes of the individual flat jet nozzles run parallel to one another.

In some embodiments of the disclosure, the applicator can include an elongated lance with a lance head at the distal end of the lance, the applicator head being attached to the lance head. The connection between the applicator head on the one hand and the lance head on the other hand can be detachable. It should also be mentioned that the lance can be rotatable relative to the mounting flange of the applicator. A rotary feed-through can be provided here in order to be able to guide the application agent through the rotary feed-through to the nozzles in various rotational positions of the lance.

Mounting the nozzles directly and immediately in the applicator head according to the disclosure makes it possible to favorably reduce the interfering contour of the applicator head. Thus, the interfering contour at right angles to the lance can have a maximum lateral extension that can be smaller than 200 mm, 150 mm, 100 mm or 80 mm. In a side view transverse to the lance, the interfering contour can have a maximum extension of less than 200 mm, 150 mm, 100 mm or 80 mm.

It was already briefly mentioned at the beginning that the applicator can also have a valve unit for controlling the material flow of the application agent to the nozzles, whereby the valve unit can enable selective material dispensing from the individual nozzles. In some embodiments, this valve unit is located in the lance head.

In some embodiments of the disclosure, a main valve is provided for each of the individual nozzles to control the material flow of the application agent to the nozzles. There is no other valve between the main valves and the associated nozzles, so that the main valves control the material flow from the associated nozzles. The line length between the individual main valves and the associated nozzles is preferably relatively short and can be less than 50 cm, 25 cm, 20 cm, 10 cm or 5 cm. This short line length is advantageous for fast and dynamic response behavior and prevents dripping from the nozzles when the main valves are closed.

In addition, material circulation of the application agent can be provided upstream of the valve unit. The applicator according to the disclosure therefore has a feed line and a return line. The feed line leads the application agent to the valve unit, while the return line leads the application agent back from the valve unit.

It should also be mentioned in general that the nozzles can be airless nozzles or flat jet nozzles, for example, as are known from the prior art. The individual nozzles can emit their jets in different directions.

Finally, it should also be mentioned that the disclosure does not only claim protection for the applicator described above as an individual component. Rather, the disclosure also claims protection for an application robot with such an applicator.

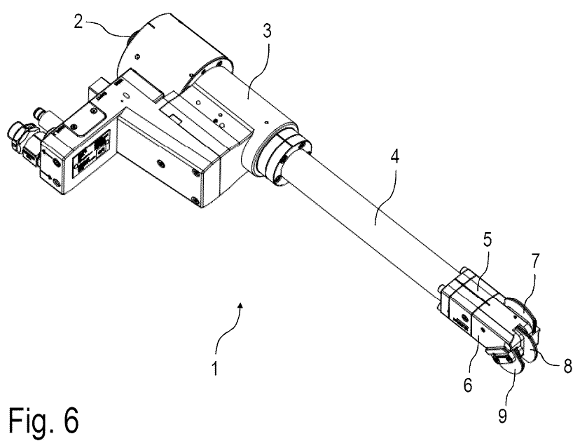

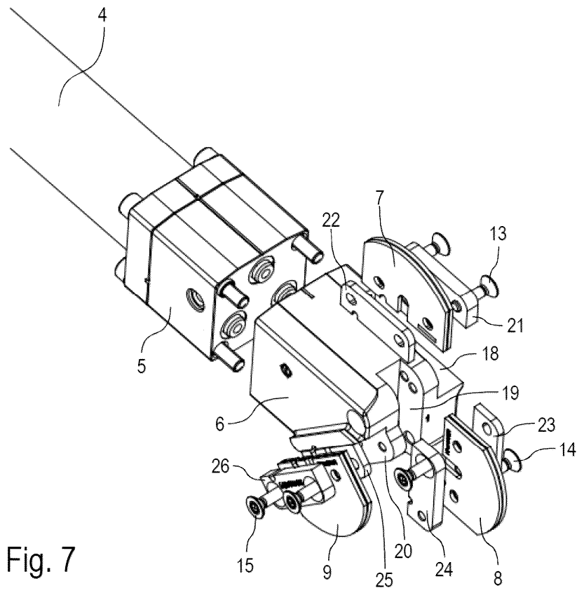

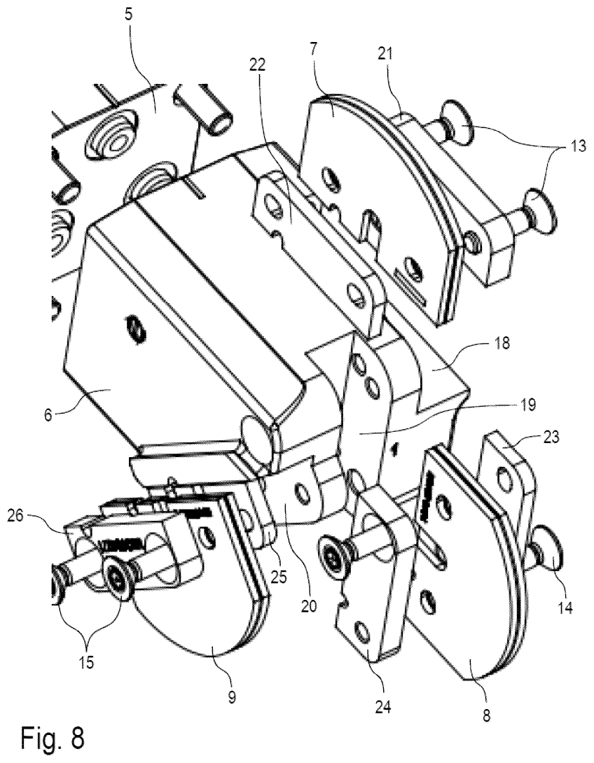

The applicator 1 according to the disclosed technology, as shown in FIGS. 5-11, is now described below. The applicator 1 according to the disclosure largely corresponds to the conventional applicator 1 as shown in FIGS. 1-4. To avoid repetition, reference is therefore largely made to the above description, with the same reference signs being used for corresponding details.

A special feature of the applicator 1 according to the disclosure is that the adapters 10-12 for mounting the flat jet nozzles 7-9 in the applicator head 6 are dispensed with. Instead, the flat jet nozzles 7-9 are mounted directly and immediately in the applicator head 6. For this purpose, the applicator head 6 has three nozzle holders 18-20, in which the flat jet nozzles 7-9 are screwed by the screws 13-15. The individual flat jet nozzles 7-9 include several nozzle plates, which are clamped between two counter plates 21-20.

It should be noted here that the two nozzle holders 18, 20 each have a flat contact surface. The counter plates 22 or 25 then lie against these flat contact surfaces of the nozzle holders 18, 20.

The nozzle holder 19, on the other hand, has a mounting groove in which the flat jet nozzle 8 is mounted with the counter plates 23, 24.

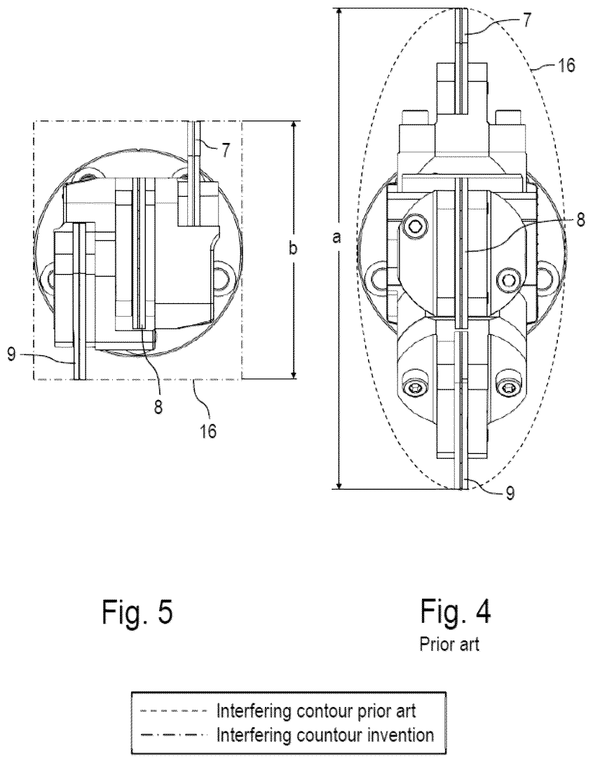

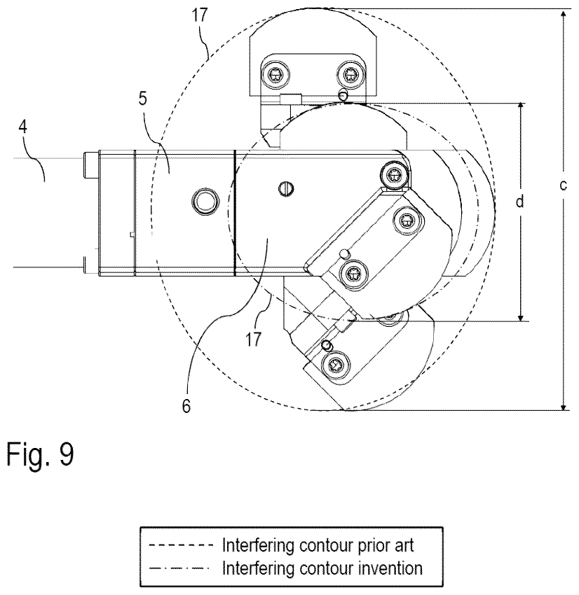

This immediate mounting of the flat jet nozzles 7-9 in the applicator head 6 makes it possible to reduce the interfering contours 16 and 17, as can be seen in FIGS. 4, 5, and 9. With reference to FIG. 5, the interfering contour 16 of the applicator 1 according to the disclosure only has a lateral extension b which is less than the lateral extension a of the conventional applicator shown in FIG. 4. The interfering contour 17 of the applicator 1 according to the disclosure is d which is less than c of the conventional applicator, as can be seen in FIG. 9.

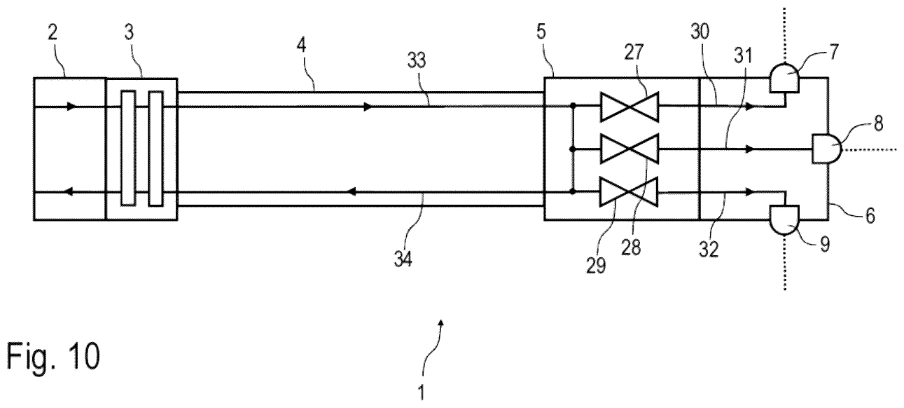

The schematic representation of the applicator 1 according to the disclosure as shown in FIG. 10 is now described below.

It should be mentioned here that three main valves 27-29 are arranged in the lance head 5, which control the material discharge from the flat jet nozzles 7-9. The main valves 27-29 are connected to the flat jet nozzles 7-9 via lines 30-32. The short line length of the lines 30-32 is advantageous here, which enables rapid response behavior and prevents dripping when the main valves 27-29 are closed.

Furthermore, it can be seen from the diagram that the applicator 1 has a material circulation system with a feed line 33 and a return line 34.

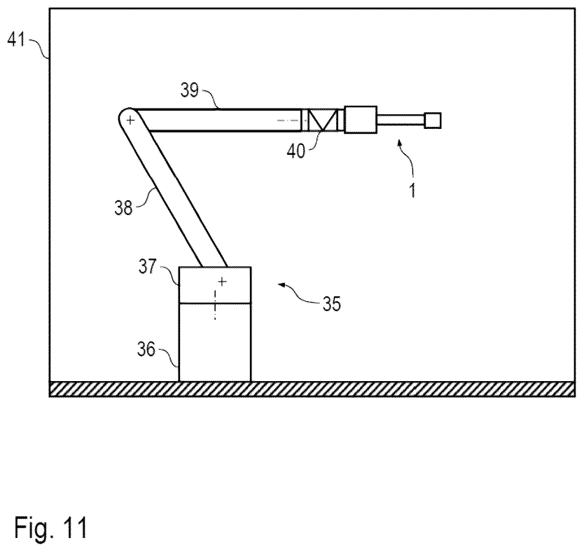

Finally, FIG. 11 shows an application robot 35 with a robot base 36, a rotatable robot member 37, a proximal robot arm 38, a distal robot arm 39, a robot hand axis 40 and the applicator 1 according to the disclosure. It should be mentioned here that the application robot 35 is arranged in an application cabin 41.

The disclosure technology provides several advantages over conventional applicators.

For example, the disclosure provides significant reduction of the interfering contour of the applicator (“3D gun”) with attached nozzles.

The disclosure also provides better accessibility to the vehicle body due to the smaller interfering contour of the applicator.

The disclosure provides weight reduction and reduced complexity, as fewer individual parts are required overall.

The disclosed reduction in the length of the material channel between the seat of the main needle (main valve) and the nozzle outlet provides an improvement in application quality.

The type of nozzle adaptation can be used for different types of nozzles.

The invention claimed is:

1.-14. (canceled)

15. An applicator for applying an application agent, comprising:
a mounting flange for mounting the applicator on an application robot, so that the applicator is guided by the application robot;
a plurality of nozzles for emitting a respective jet of the application agent onto a component, the nozzles each being designed as a separate component; and
an applicator head at the distal end of the applicator, wherein the applicator head comprises a respective nozzle holder for mounting the individual nozzles, wherein the individual nozzles are each mounted directly in the associated nozzle holders of the applicator head.

16. The applicator according to claim 15, wherein the nozzles are each anchored directly in the associated nozzle holder of the applicator head by a force-fit connection.

17. The applicator according to claim 15, wherein the nozzles are each anchored directly in the associated nozzle holder of the applicator head by a form-fit connection.

18. The applicator according to claim 17, wherein the form-fit connection is a screw connection.

19. The applicator according to claim 15, wherein:
the nozzles each have a flat contact surface;
the nozzle holders in the applicator head for mounting the nozzles each have a flat contact surface; and
the flat contact surfaces of the nozzles on the one hand and the nozzle holders on the other hand lie plane-parallel against each other in the mounted state of the nozzles.

20. The applicator according to claim 15, wherein at least one of the nozzle holders of the applicator head comprises a receiving groove for receiving one of the nozzles, and one of the nozzles is mounted in the receiving groove of the nozzle holder in the applicator head.

21. The applicator according to claim 18, wherein the screw connections between the nozzles and the associated nozzle holders are each aligned at right angles to contact surfaces of the nozzle on the one hand and of the nozzle holder on the other hand, and the screw connections are each anchored in a threaded hole in the respective contact surface of the nozzle holder of the applicator head.

22. The applicator according to claim 18, wherein:
the nozzles each have a plurality of nozzle plates which are arranged parallel to one another;
the individual nozzle plates are flat;
the nozzles each have two clamping plates, the nozzle plates being arranged between the two clamping plates; and
the screw connection passes through the two clamping plates and through the nozzle plates.

23. The applicator according to claim 15, wherein the nozzles are flat jet nozzles, each of which emits a flat jet in a respective jet plane, and the flat jet nozzles are arranged in such a way that the jet planes of the individual flat jet nozzles run parallel to each other.

24. The applicator according to claim 15, wherein:
the applicator comprises an elongated lance with a lance head at the distal end of the lance, the applicator head being attached to the lance head;
the applicator head is detachably mounted on the lance head;
the lance is rotatable relative to the mounting flange of the applicator; and
the applicator comprises a rotary feedthrough in order to be able to guide the application agent through the rotary feedthrough to the nozzles in various rotational positions of the lance.

25. The applicator according to claim 24, wherein:
the applicator head has in cross-section at right angles to the lance an interfering contour which has a maximum lateral extension of less than 200 mm, 150 mm, 100 mm or less than 80 mm; and
the applicator head has, in a side view transverse to the lance, an interfering contour which has a maximum extension transverse to the lance of less than 200 mm, 150 mm, 100 mm or less than 80 mm.

26. The applicator according to claim 15, wherein the applicator comprises a valve unit for controlling the material flow of the application agent to the nozzles wherein the valve unit enables a selective material discharge from the individual nozzles, and the valve unit is arranged in the lance head.

27. The applicator according to claim 26, wherein:
the valve unit for controlling the material flow of the application agent to the nozzles comprises a respective main valve for the individual nozzles, wherein there is no further valve between the main valves and the associated nozzles, so that the main valves control the material flow from the associated nozzles;
the individual main valves are each connected to the associated nozzles by a line; and
the lines from the main valves to the nozzles each have a line length of less than 50 cm.

28. The applicator according to claim 27, wherein the lines from the main valves to the nozzles each have a line length of less than 20 cm.

29. The applicator according to claim 27, wherein the lines from the main valves to the nozzles each have a line length of less than 10 cm.

30. The applicator according to claim 27, further comprising a material circulation system upstream of the valve unit with a feed line for supplying the application agent to the valve unit and a return line for returning the application agent from the valve unit.

31. The applicator according to claim 15, wherein:
the nozzles are flat jet nozzles, each of which emits a flat jet of the application agent;
the applicator comprises exactly three nozzles; and
the nozzles emit their jets in different directions.

32. An application robot with an applicator according to claim 15.
